(19) United States
(12) Patent Application Publication
(10) Pub. No.: US 2022/0301747 A1
(43) Pub. Date: Sep. 22, 2022

(54) High-Power Resistor

(71) Applicant: Holy Stone Enterprise Co., Ltd., Taipei (TW)

(72) Inventors: Jui-Hsiang Chen, Taipei (TW); Kuei-Fang Huang, Taipei (TW); I-Hung Chiang, Taipei (TW); Kun-Chan Yen, Taipei (TW)

(21) Appl. No.: 17/538,279

(22) Filed: Nov. 30, 2021

(30) Foreign Application Priority Data
Mar. 19, 2021 (TW) 110110044

(51) Int. Cl. H01C 1/084; H01C 1/012; H01C 1/142

(52) U.S. Cl. CPC H01C 1/084; H01C 1/012; H01C 1/142

(57) ABSTRACT

A high-power resistor includes a substrate, a resistor layer, two edge electrodes, and a seed layer. The substrate has a first surface. The resistor layer is mounted on the first surface of the substrate. The two edge electrodes are mounted on the resistor layer. The seed layer is mounted between the resistor layer and the two edge electrodes. A contacting surface between one of the two edge electrodes and the resistor layer is bigger than contacting side surfaces of a printed resistor layer and printed conduction layers from a conventional chip resistor, creating less electrical resistance. When high-power electricity passes through the resistor layer, heat generated by a large passing current can be equally dissipated in all directions on the contact surface. With less electrical resistance and better heat dissipation, the contacting surface enables the high-power resistor to tolerate greater electric power.

### CROSS-REFERENCE TO RELATED APPLICATIONS

This application claims the priority benefit of TW application serial No. 109125235 filed on Jul. 27, 2020, and the priority benefit of TW application serial No. 110110044 filed on Mar. 19, 2020, the entirety of which is hereby incorporated by reference herein and made a part of specification.

### BACKGROUND OF THE INVENTION

### 1. Field of the Invention

The present invention relates to a resistor, more particularly a high-power resistor.

### 2. Description of the Related Art

With reference to FIG. 13, a conventional chip resistor is shown. The conventional chip resistor includes a printed resistor layer 81 and two printed conductive layers 82. The printed resistor layer 81 is mounted on a substrate 80. The two printed conductive layers 82 are used to conduct electricity between the printed resister layer 81 and an external circuit. The conventional chip resistor requires the two printed conductive layers 82 and the printed resistor layer 81 to be first printed on the substrate 80 in corresponding order, and then sintered in order to form, and keep the two printed conductive layers 82 and the printed resistor layer 81 in place on the substrate 80. Usually the two printed conductive layers 82 are mounted on two opposite sides of the printed resistor layer 81, and the two printed conductive layers 82 further contact surfaces of the two opposite sides of the printed resistor layer 81, forming electrical connections correspondingly for conducting electricity from one side of the printed resistor layer 81 to another side of the printed resistor layer 81. The two printed conductive layers 82 and the printed resistor layer 81 are therefore electrically connected in series.

After printing the printed conductive layers 82 and before sintering the printed conductive layers 82, edges of the printed conductive layers 82 are prone to tilting and collapsing due to material property reasons. The tilting and collapsing of edges of the printed conductive layers 82 makes the printed resistor layer 81 clad on the tilted edges of the printed conductive layers 82, forming a tilted surface 810 upon sintering. Since both the printed resistor layer 81 and the two printed conductive layers 82 are only about 50 nanometers (nm) to 15 micrometers (μm) thick, widths of contact surfaces between the printed resistor layer 81 and the two printed conductive layers 82 are also about 50 nm to 15 μm. When a high current passes through the contact surfaces between the printed resistor layer 81 and the two printed conductive layers 82, the tilted surface 810 will easily heat up due to high resistance created by small electricity pathways of the contact surfaces. After heating up and cooling down repeatedly, stress and strain of repeated expanding and shrinking can cause dislocations between the printed resistor layer 81 and the two printed conductive layers 82, decreasing reliability of the chip resistor.

With reference to FIG. 14, another conventional chip resistor (also known as a former case) is shown, revealing a low resistance chip resistor. The low resistance chip resistor includes a substrate 90, a resistor layer 91, a conduction layer 92, a protection layer 93, a first cover layer 94, and a second cover layer 95, The conduction layer 92 is mounted on the resistor layer 91. However, the former case only mentions the conduction layer 92 is made of copper and mentions how the conduction layer 92 is mounted on the resistor layer 91 by plating. Since the resistor layer 91 of the former case is a conductor with less ideal electrical conductance as copper, how exactly copper is plated on the resistor layer 91 is unknown from the former case. Even if plated, the conduction layer 92 would only be unstably mounted on the resistor layer 91. Due to such instability and due to a limitation in thickness, the conduction layer 92 struggles to be considered an ideal conductor for the resistor layer 91 and the external circuit. In addition, electrodes on the side of the former case also lacks adequate connectivity, causing concerns of whether silver ions can be blocked from entering inside of the resistor.

### SUMMARY OF THE INVENTION

To overcome the drawbacks of an unstable structure connecting a printed resistor layer of a conventional chip resistor and two printed conductive layers, the present invention provides a high-power resistor. The high-power resistor of the present invention includes:

a substrate, having a first surface;

a resistor layer, mounted on the first surface of the substrate;

two edge electrodes, mounted on the resistor layer; and

a seed layer, mounted between the resistor layer and the two edge electrodes, and being electrically conductive.

In a manufacturing process of the high-power resistor, after the resistor layer is mounted on the substrate, the seed layer is mounted on the resistor layer before further mounting the two edge electrodes on the seed layer. Since the seed layer is mounted first on the resistor layer, a cladding process such as rack plating is used for mounting the edge electrodes on the seed layer. As a result, the two edge electrodes are located on the resistor layer and are mounted overlapping the resistor layer, rather than only contacting side surfaces of the resistor layer. In the high-power resistor of the present invention, a contacting surface between one of the two edge electrodes and the resistor layer is a projected area of one of the two edge electrodes perpendicular to the substrate. The contacting surface is much bigger than contacting side surfaces of the printed resistor layer and the printed conduction layers from the prior art. As a result, a current flows between the edge electrodes and the resistor layer with less electrical resistance in the high-power resistor of the present invention.

Since the manufacturing process of the high-power resistor excludes mounting the printed resistor layer and the printed conductive layers, sintering can be avoided, and since the contacting surface between the edge electrodes and the resistor layer becomes bigger, tilting and collapsing of the contacting surface from circuit printing and sintering can also be avoided, ensuring manufacturing stability, precision, and better efficiency.

The high-power resistor of the present invention is made by the aforementioned manufacturing process. The edge electrodes connecting an external power source is mounted overlapping the resistor layer via the seed layer on the resistor layer. The contacting surface between one of the two edge electrodes and the resistor layer is the projected area vertically projected from one of the two edge electrodes to the substrate. The projected area is far bigger than contacting side surfaces of the printed resistor layer and the printed conduction layers from the prior art.

When high-power electricity passes through the resistor layer, heat generated by large passing current between the resistor layer and the two edge electrodes can be equally dissipated in all directions on the contact surface. With the contact surface being bigger, the contact surface prevents damage due to excessive high temperatures, enabling the high-power resistor to tolerate greater electric power. Furthermore, by having the seed layer, the two edge electrodes and the resistor layer benefit for having stable structures and having stable electrical connections. The seed layer decreases electrical resistance between the two edge electrodes and the resistor layer, making the high-power resistor performing stably, and making the high-power resistor more tolerant of electrical resistance fluctuations for the resistor layer and the two edge electrodes.

### BRIEF DESCRIPTION OF THE DRAWINGS

FIGS. 1 to 5B are cross-sectional perspective views of embodiments of a high-power resistor of the present invention.

FIG. 6 is a top perspective view another embodiment of the high-power resistor of the present invention.

FIGS. 7 to 9 are additional cross-sectional perspective views of embodiments of the high-power resistor of the present invention.

FIG. 10 is a cross-sectional perspective view of another embodiment of the high-power resistor of the present invention.

FIG. 11 is a simplified circuit diagram of the high-power resistor of the present invention.

FIG. 12 is a test data diagram of samples of the high-power resistor of the present invention.

FIG. 13 is a cross-sectional perspective view of a conventional chip resistor.

FIG. 14 is a perspective view of an embodiment of the conventional chip resistor.

### DETAILED DESCRIPTION OF THE INVENTION

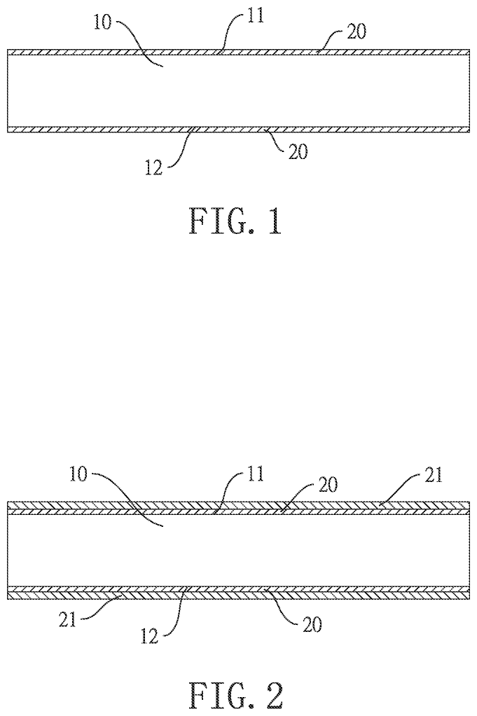

With reference to FIGS. 1 to 8, the present invention provides a high-power resistor. The high-power resistor is manufactured in the following steps:

preparing a substrate 10;

mounting a resistor layer 20 on a first surface 11 of the substrate 10;

mounting a seed layer 21 on the resistor layer 20;

mounting two edge electrodes 31 on the seed layer 21;

removing parts of the seed layer 21 and parts of the resistor layer 20 to form a resistor pattern from the remained seed layer 21 and the remained resistor layer 20; and

removing parts of the remained seed layer 21 exposed by the two edge electrodes 31 to expose the remained resistor layer.

With reference to FIG. 1, in an embodiment of the present invention, the resistor layer 20 is sputtered on the first surface 11. More particularly, when taking steps to mount the resistor layer 20 on the first surface 11 of the substrate 10, sputtering is used to completely cover the first surface 11 of the substrate 10 with the resistor layer 20. Preferably, another resistance layer 20 can be mounted simultaneously on a second surface 12 opposite of the first surface 11 of the substrate 10. This way the manufacturing process for electrically connecting edge electrodes can simultaneously proceed for both surfaces 11,12 of the high-power resistor. Further, a sputtering material for the resistor layer 20 can be materials such as titanium alloy, nickel-chromium alloy, copper-silver alloy, nickel-chromium-copper alloy, nickel-chromium-silicon alloy, manganese-copper alloy, nickel-copper alloy, titanium nitride, and tantalum-aluminium-nitride. The sputtering material for the resistor layer 20 can be chosen freely to be other materials. A main function of the sputtering material is to provide adequate resistance for the resistor layer. Any metal or metal and non-metal compound materials with resistance properties can be candidates for the sputtering material.

With reference to FIG. 2, in another embodiment of the present invention, after the resistor layer 20 is sputtered, further sputter a seed layer 21 for mounting on the resistor layer 20. Further, another seed layer 21 can be mounted simultaneously on the resistor layer 20 on the second surface 12. More particularly, the present invention sputters the seed layer 21 to completely cover the resistor layer 20. A material resistance ρ1 of the resistor layer 20 is greater than a material resistance ρ2 of the seed layer 21. A sputtering material for the seed layer 21 is the same metallic material as the two edge electrodes 31. Therefore, in this case the material resistance ρ1 of the resistor layer 20 is also greater than the material resistance of the two edge electrodes 31. By using the same metallic material, the edge electrodes 31 can be formed stably and closely connecting the seed layer 21 when mounted on the seed layer 21. For example, if the edge electrodes 31 are made out of copper, the sputtering material for the seed layer 21 should best be copper too. However the present invention freely allows any material choices, in other words, different metallic materials can be used for the edge electrodes 31 and the seed layer 21 to suit different needs.

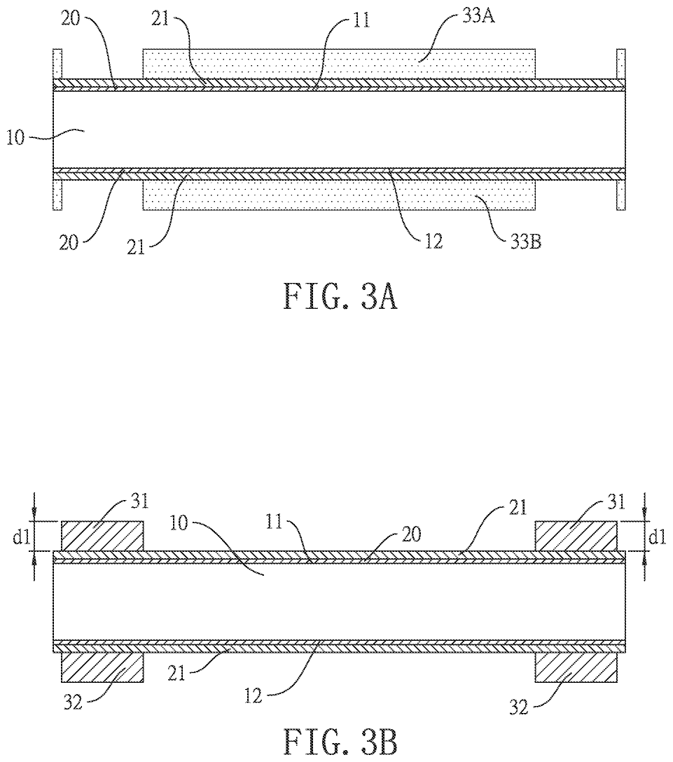

With reference to FIGS. 3A and 3B, in another embodiment of the present invention, the step of mounting the two edge electrodes 31 on the seed layer 21 includes the following sub-steps:

with reference to FIG. 3A, forming a patterned photoresist layer 33A to partially cover the seed layer 21, wherein parts of the patterned photoresist layer 33A also partially exposes the seed layer 21;

with reference to FIG. 3B, forming the two edge electrodes 31 on the exposed parts of the seed layer 21 by plating, wherein the exposed parts of the seed layer 21 are locations on the seed layer 21 partially exposed by the patterned photoresist layer 33A.

More particularly, after the seed layer 21 covers the resistor layer 20, the exposed parts of the seed layer 21 reserved for mounting the two edge electrodes 31 are lithographically created through the patterned photoresist layer 33A covered on the seed layer 21. The exposed parts of the seed layer 21 reserved for mounting the two edge electrodes 31 each has an area of dimension 0.7 millimeters (mm)*0.7 mm to 1.5 mm*1.5 mm in another embodiment of the present invention. Once the areas cleared, the two edge electrodes 31 are mounted in the areas by plating. Further, rack plating is used to make the two edge electrodes 31 thick. A thickness d1 for the two edge electrodes 31 can reach 30 to 100 micrometers (micron; μm) or even greater. Therefore, the areas are basically contact areas. The seed layer 21 is used as an intermedia in the contact areas between the two edge electrodes 31 and the resistor layer 20, and the seed layer 21 has a dimension of 0.7 millimeters (mm)*0.7 mm to 1.5 mm*1.5 mm.

The two edge electrodes 31 are mounted overlapping the resistor layer 20 with the contact area, and the contact area is an overlapping surface 311 of the two edge electrodes 31. Comparing to side surfaces connecting the printed resistor layer and the printed conduction layer of a conventional chip resistor with a width of 50 nanometers (nm) to 15 μm, the overlapping surface 311 of the present invention has greater surface area to conduct electricity. Furthermore, since after mounting the seed layer 21 the present invention uses rack plating, the thickness of the two edge electrodes 31 of the present invention is far greater than the printed conduction layer. Overall, since the overlapping surface 311 is greater and the thickness of the two edge electrodes 31 is thicker, the edge electrodes 31 have better heat dissipating properties. When a high current passes through the high-power resistor, the heat generated by the high current from the overlapping surface 311 is dissipated from the two edge electrodes 31 directly, preventing the heat from damaging the high-power resistor with high temperature, and improving a power tolerance of the high-power resistor.

Furthermore, when mounting the two edge electrodes 31, two bottom electrodes 32 are simultaneously mounted on the second surface 12 of the substrate 10. With reference to FIG. 3A, a patterned photoresist layer 33B partially covers and partially exposes the seed layer 21 on the second surface 12. When plating is used to form the two edge electrodes 31, the two bottom electrodes 32 are simultaneously mounted on the seed layer 21 on the second surface 12.

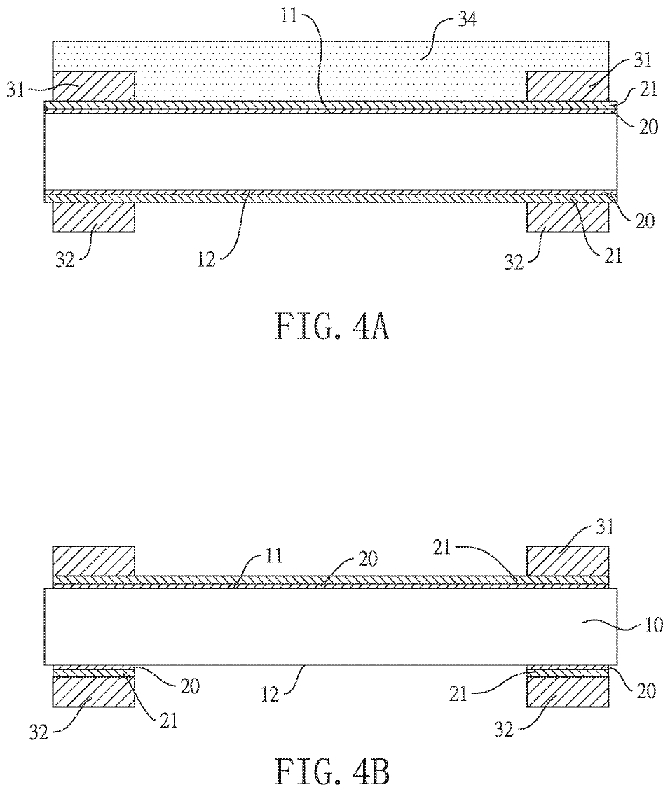

With reference to FIGS. 4A and 4B, in another embodiment of the present invention, the seed layer 21 and the resistor layer 20 are partially removed to form a resistor pattern with the following sub-steps:

with reference to FIG. 4A, covering a first patterned photoresist layer 34 on the seed layer 21 and the two edge electrodes 31, wherein the first patterned photoresist layer 34 has a corresponding pattern to the resistor pattern;

with reference to FIG. 4B, removing parts of the seed layer 21 exposed through the first patterned photoresist layer 34 and parts of the resistor layer 20, and then removing the first patterned photoresist layer 34.

After the edge two electrodes 31 are mounted on the seed layer 21, a next step is to remove any remains of the seed layer 21 and the resistor layer 20 other than the resistor pattern on the first surface 11 of the substrate 10. First the first patterned photoresist layer 34 covers on the seed layer 21, wherein the first patterned photoresist layer 34 covers a pattern needed to be preserved for forming the resistor pattern. Then parts of the seed layer 21 exposed through the first patterned photoresist layer 34 and parts of the resistor layer 20 are removed, preserving only parts of the seed layer 21 and parts of the resistor layer 20 for forming the resistor pattern. Further, parts of the seed layer 21 and parts of the resistor layer 20 are removed separately by etching, and in the end, the first patterned photoresist layer 34 is also removed.

When the remains of the seed layer 21 and the resistor layer 20 are removed, simultaneously removes remains of the seed layer 21 and the resistor layer 20 on the second surface 12 of the substrate 10. Since only the bottom electrodes 32 on the second surface 12 needs to be preserved, when etching to remove the seed layer 21 and the resistor layer 20 on the first surface 11, parts of the seed layer 21 and parts of the resistor layer 20 exposed by the two bottom electrodes 32 are simultaneously removed.

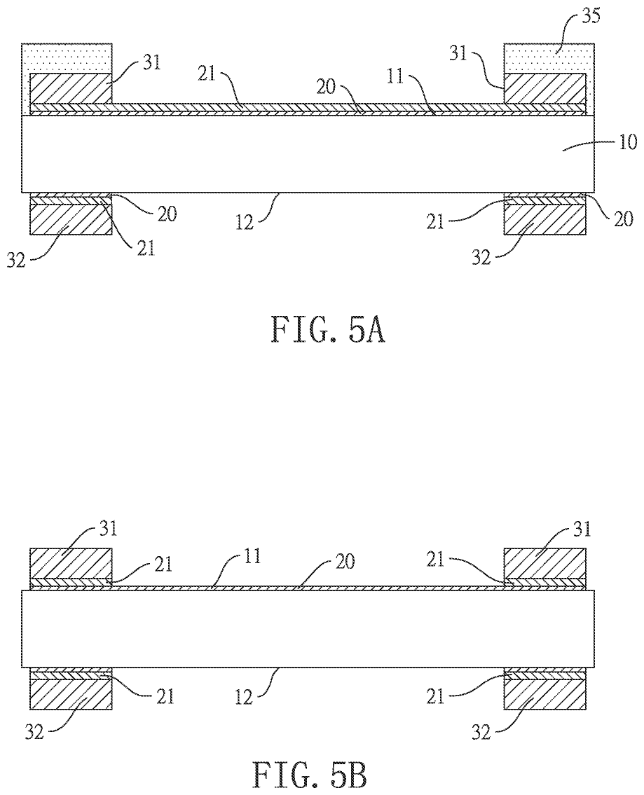

With reference to FIGS. 5A and 5B, in another embodiment of the present invention, remove another part of the seed layer 21 exposed by the two edge electrodes 31 in the resistor pattern. The step of exposing the resistor layer 20 of the resistor pattern includes the following sub-steps:

with reference to FIG. 5A, forming a second patterned photoresist layer 35 on the substrate 10, wherein the second patterned photoresist layer 35 covers the two edge electrodes 31 and surface areas exposed by the resistor pattern on the substrate 10;

with reference to FIG. 5B, removing parts of the seed layer 21 exposed by the second patterned photoresist layer 35, exposing parts of the resistor layer 20 exposed by the two edge electrodes 31 in the resistor pattern, and removing the second patterned photoresist layer 35.

After forming the resistor pattern for the seed layer 21 and the resistor layer 20 on the first surface 11, a next step is to remove the seed layer 21 redundant in the resistor pattern. Therefore the next step is to cover the two edge electrodes 31 and parts of the first surface 11 exposed by the resistor pattern with the second patterned photoresist layer 35, and then to etch the seed layer 21 covered by the resistor pattern away, and to expose the resistor layer 20 in the resistor pattern. Further, etching methods are utilized to remove the seed layer 21 and to expose the resistor layer 20 in the resistor pattern. As such, the resistor layer 20 with a desired electrical resistance is complete in the high-power resistor of the present invention. The high-power resistor of the present invention includes the substrate 10, the resistor layer 20, the two edge electrodes 31, and the seed layer 21. The substrate 10 has the first surface 11, the resistor layer 20 is mounted on the first surface 11, the two edge electrodes 31 are mounted on the resistor layer 20, and the seed layer 21 is mounted between the resistor layer 20 and the two edge electrodes 31.

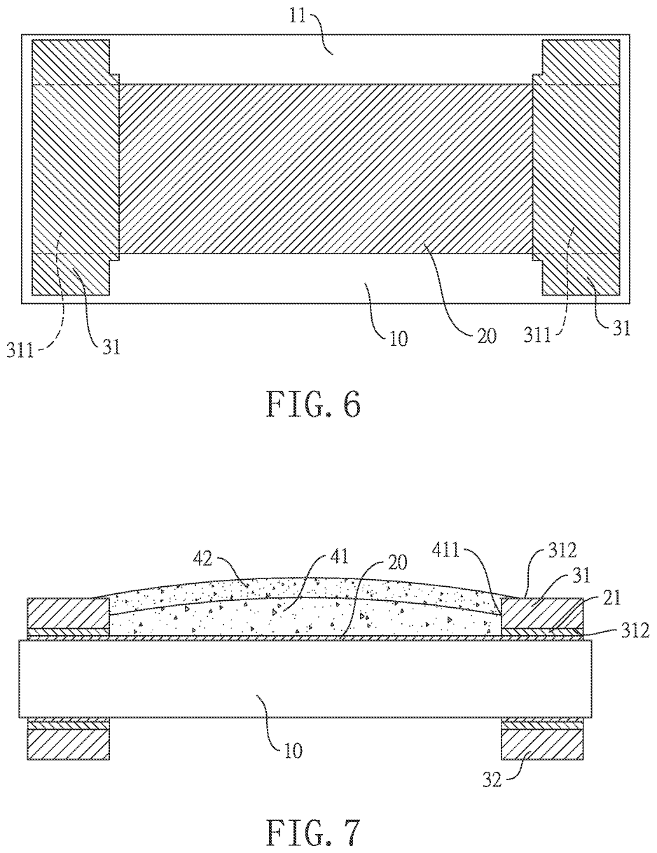

With reference to FIG. 6, from a top perspective view of the high-power resistor, the resistor layer 20 and the two edge electrodes 31 are mounted on the first surface 11 of the substrate 10. Since the overlapping surface 311 is mounted between the resistor layer 20 and the two edge electrodes 31, and since the seed layer 21 is the intermedia between the two edge electrodes 31 and the resistor layer 20, a contacting surface between the two edge electrodes 31 and the resistor layer 20 benefits for having small and stable electrical resistance. Small electrical resistance allows high current to pass through, and stable electrical resistance is coupled with good heat dissipation, as heat created by current passing through the contacting surface can be effectively dissipated through the two edge electrodes 31 via heat conduction.

With further reference to FIG. 7, after forming the resistor layer 20 and the two edge electrodes 31 on the substrate 10 of the high-power resistor, further steps will be taken to form protective layers for the resistor layer 20. In particular, after exposing the resistor layer 20 in the resistor pattern, the present invention further includes the following steps:

forming a first protective layer 41 on the resistor layer 20, wherein the first protective layer 41 covers a surface area of the resistor layer 20 between the two edge electrodes 31, and wherein a height of an edge 411 of the first protective layer 41 contacting the two edge electrodes 31 is lower than a height of a top surface 312 of the two edge electrodes 31; and

forming a second protective layer 42 on the first protective layer 41.

The high-power resistor further includes the first protective layer 41 and the second protective layer 42. The first protective layer 41 covers the resistor layer 20 between the two edge electrodes 31, and the height of the edge 411 of the first protective layer 41 along the two edge electrodes 31 is lower than the height of the two edge electrodes 31. The second protective layer 42 is mounted on the first protective layer 41, covering the first protective layer 41.

The first protective layer 41 and the second protective layer 42 are used to cover the resistor layer 20, protecting the resistor layer 20 from physical or chemical harms. In particular, the first protective layer 41 and the second protective layer 42 are used to insulate the resistor layer 20 from contacting air, since air contains erosive water vapor. The first protective layer 41 and the second protective layer 42 are made out of materials such as synthetic resin, and in particular, electrically insulating synthetic resin having a curing temperature between 150° C. to 450° C. In the present invention, the first protective layer 41 and the second protective layer 42 are free to be made out of other materials. Furthermore, in the present embodiment, the first protective layer 41 covers a surface of the resistor layer 20 and is cured, and then the second protective layer 42 covers the first protective layer 41 and is also cured, sealing any potential gaps around the first protective layer 41, and completely insulating the resistor layer 20 from any outside air.

With reference to FIG. 7, since the two edge electrodes 31 are mounted overlapping the resistor layer 20, and since the two edge electrodes are formed by plating, or rather particularly in another embodiment, formed by rack plating, the two edge electrodes each has thickness about 30 to 100 μm. In other words, the top surface 312 of the two edge electrodes 31 is higher than the surface of the resistor layer 20 by 30 to 100 μm. As a result, when the first protective layer 41 covers the resistor pattern of the resistor layer 20, the height of the first protective layer 41 is lower than the height of the two edge electrodes 31. The first protective layer 41 connects with side surfaces of the two edge electrodes 31 along edges of the two edge electrodes 31, and the second protective layer 42 then covers the first protective layer 41. In other words, the resistor layer 20 is distanced away from the edge 411 of the first protective layer 41. This way, even if there are small cracks leaking water vapor through to the second protective layer 42 along edges of the second protective layer 42, the water vapor would only be able to reach a surface of the first protective layer 41, rather than be able to penetrate the edge 411 of the first protective layer 41 into the resistor layer 20.

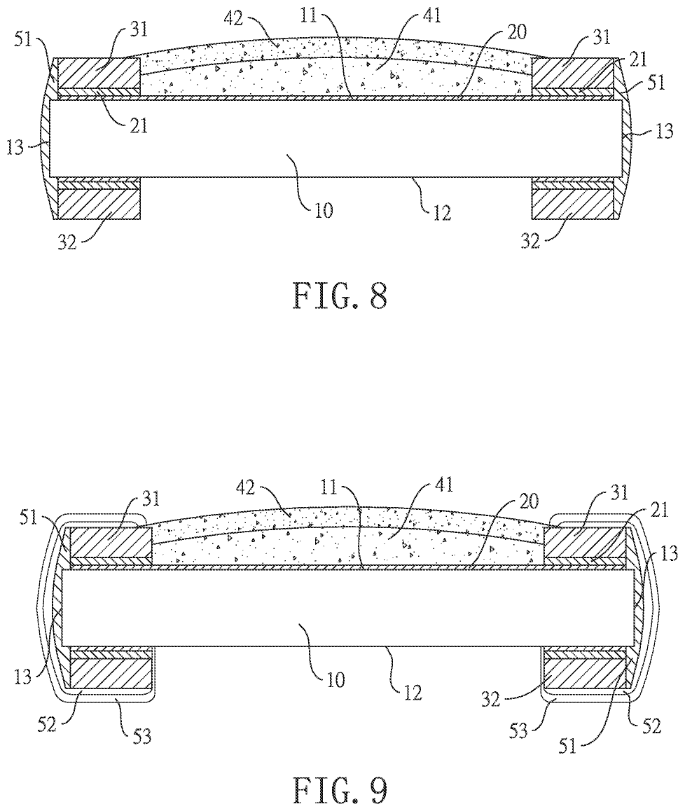

With reference to FIGS. 8 and 9, after exposing the resistor layer 20 on the first surface 11 of the substrate 10, and after forming the protective layers 41, 42 on the resistor layer 20, the present invention further includes the following steps:

with reference to FIG. 8, forming a side surface seed layer 51 on each of two side surfaces 13 of the substrate 10, wherein the side surface seed layers 51 stretch from the first surface 11 to a second surface 12 opposite to the first surface 11 on the substrate 10, and wherein the two edge electrodes 31 on the first surface 11 electrically connect the two bottom electrodes 32 on the second surface 12;

with reference to FIG. 9, forming two first conducting layers 52 on the side surface seed layers 51, and forming two second conducting layers 53 on the two first conducting layers 52.

The substrate 10 further has the two side surfaces 13, the first surface 11, and the second surface 12 facing opposite direction to the first surface 11. The high-power resistor further includes the two bottom electrodes 32, the side surface seed layers 51, the two first conducting layers 52, and the two second conducting layers 53. The two bottom electrodes 32 are mounted on the second surface 12. The side surface seed layers 51 are mounted on the two side surfaces 13, stretching from the first surface 11 to the second surface 12, and electrically connecting the two edge electrodes 31 and the two bottom electrodes 32. The two first conducting layers 52 are mounted on the two side surfaces 13, and the two second conducting layers 53 are mounted on the two first conducting layers 52.

A goal is to form an electrical connection between the two edge electrodes 31 and the two bottom electrodes 32. To achieve the goal, first the side surface seed layers 51 are mounted on the two side surfaces 13 of the substrate 10. The side surface seed layers 51 are made with metallic materials such as tin, silver, nickel, copper, or palladium, and by process of coating, deposition, or sputtering. This way the side surface seed layers 51 can cover the two side surfaces 13 of the substrate 10, can stretch to the first surface 11 and the second surface 12, and can coat the two side surfaces 13 of the two edge electrodes 31 and the two bottom electrodes 32, achieving the goal of electrically connecting the two edge electrodes 31 and the two bottom electrodes 32.

Additionally the two first conducting layers 52 and the two second conducting layers 53 are mounted on the side surface seed layers 51, ensuring good electrical connection between the two edge electrodes 31 and the two bottom electrodes 32. The two second conducting layers 53 are mounted on a Tin layer outside of the two first conducting layers 52 by a plating method such as barrel plating, mainly for wielding the high-power resistor through the tin layer with an external circuit board. The present embodiment is characterized in that the side surface seed layers 51 are mounted on the two side surfaces 13 of the substrate 10, causing the two first conducting layers 52 to be closely connecting the two side surfaces 13 of the substrate 10 via an intermedia as the side surface seed layers 51.

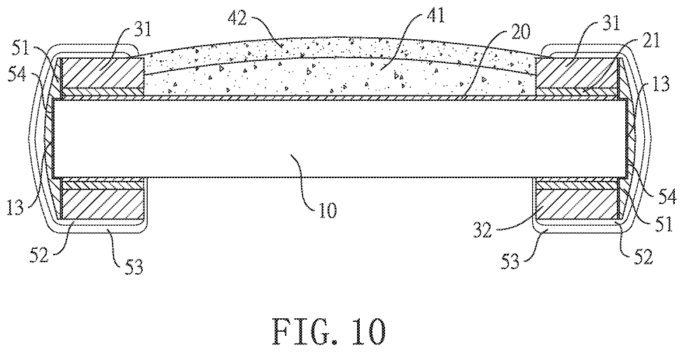

With reference to FIG. 10, the high-power resistor further includes two intermedia layers 54. The two intermedia layers 54 are mounted between the side surface seed layers 51 and the two side surfaces 13 of the substrate 10, and the two intermedia layers 54 are made out of metallic materials such as titanium or copper. For ensuring ideal sealing conditions for the side surface seed layers 51 on the two side surfaces 13 of the substrate 10, before sputtering the side surface seed layers 51 on the two side surfaces 13, first pre-sputter a thin layer of titanium or copper on locations preparing to be sputtered with the side surface seed layers 51. The pre-sputtered thin metallic layer act as the intermedia layer 54 between the substrate 10 and the side surface seed layer 51, and the pre-sputtered thin metallic layer is less than or equal to 100 nanometer (nm) thick. As a metallic material, titanium sticks to the substrate 10 well, and titanium effectively prevents ionic migrations of silver ions or other metallic ions. Titanium also demonstrates good connection with other metals later in the manufacturing process, and titanium demonstrates low levels of oxidization, preventing any potential pealing between the substrate 10 and the two side surfaces 13.

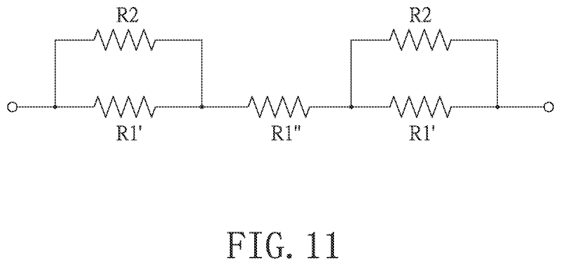

With reference to FIG. 11, FIG. 11 is a simplified circuit diagram formed by the two edge electrodes 31 and the resistor layer 20 of the high-power resistor. An equivalent resistance of the high-power resistor is an equivalent resistance of the resistor layer 20 and an equivalent resistance of the two edge electrodes 31 connected in parallel summed in series. When a current enters through the two second conducting lavers 53 and the two first conducting layers 52, the current first enters one of the two edge electrodes 31 (with equivalent resistance R2), then passes through the surface between one of the two edge electrodes 31 and the resistor layer 20 to enter an overlapping part of the resistor layer 20 (with equivalent resistance R1′). The current then passes through an exposed part (a without overlapping part) of the resistor layer 20 (with equivalent resistance R1″), enters another overlapping part of the resistor layer 20 with the other one of the two edge electrodes 31 (with equivalent resistance R1′), and then enters the other one of the two edge electrodes 31 through the corresponding surface between the other one of the two edge electrodes 31 and the resistor layer 20 (with equivalent resistance R2). The two edge electrodes 31 and the overlapping parts of the resistor layer 20 described above are electrically connected in parallel. As a result, the equivalent resistance between the two edge electrodes 31 of the high-power resistor can be calculated as:

R3=(R1′*R2)/(R1′+R2)+R1″+(R1′*R2)/(R1′+R2).

To put simply, the current passing through the two edge electrodes 31 and the resistor layer 20 encounters equivalent resistance of individual resistances first connected in parallel then in series, improving power tolerance for the high-power resistor.

The following tables demonstrate test results for reliability tests of the high-power resistor of the present invention. In the reliability tests, resistors specified for 0.5 Watt (W) power and of 6 ohms (Ω), 11Ω, 110Ω, and 280Ω resistance (R) are being tested. The testing conditions are to put the resistors under 0.5 W, 0.75 W, 1 W, and 2 W designated power for 60 seconds of constant voltage (CV) and of constant current (CC) for reliability tests. The reliability test examines whether the high-power resistor of the present invention performs stably under the above specified testing conditions. The test results are written either as PASS or N/A. While PASS means passing the test, N/A means the resistor broke during the test and therefore failed the test.

The following tables 1A and 1B demonstrate test results of 30 resistors of

6Ω resistance.

TABLE 1A

| | | Designated Power (W): | | Designated Power (W): | |
|---|---|---|---|---|---|
| | | 0.531148 | | 0.722951 | |
| | | CV (V) | CC (A) | CV (V) | CC (A) |
| | R (Ω) | 1.8 | 0.295082 | 2.1 | 0.344262 |
| Set 1 | 6.1 | PASS | PASS | PASS | PASS |
| Set 2 | 6.1 | PASS | PASS | PASS | PASS |
| Set 3 | 6 | PASS | PASS | PASS | PASS |
| Set 4 | 6.1 | PASS | PASS | PASS | PASS |
| Set 5 | 6.1 | PASS | PASS | PASS | PASS |
| Set 6 | 6.3 | PASS | PASS | PASS | PASS |
| Set 7 | 6.2 | PASS | PASS | PASS | PASS |
| Set 8 | 6 | PASS | PASS | PASS | PASS |
| Set 9 | 5.9 | PASS | PASS | PASS | PASS |
| Set 10 | 6.1 | PASS | PASS | PASS | PASS |
| Set 11 | 5.4 | PASS | PASS | PASS | PASS |
| Set 12 | 5.4 | PASS | PASS | PASS | PASS |
| Set 13 | 5.4 | PASS | PASS | PASS | PASS |
| Set 14 | 5.4 | PASS | PASS | PASS | PASS |
| Set 15 | 5.5 | PASS | PASS | PASS | PASS |
| Set 16 | 5.9 | PASS | PASS | PASS | PASS |
| Set 17 | 5.9 | PASS | PASS | PASS | PASS |
| Set 18 | 6 | PASS | PASS | PASS | PASS |
| Set 19 | 5.9 | PASS | PASS | PASS | PASS |
| Set 20 | 6 | PASS | PASS | PASS | PASS |
| Set 21 | 6.3 | PASS | PASS | PASS | PASS |
| Set 22 | 6.3 | PASS | PASS | PASS | PASS |
| Set 23 | 6.1 | PASS | PASS | PASS | PASS |
| Set 24 | 6.2 | PASS | PASS | PASS | PASS |
| Set 25 | 6.2 | PASS | PASS | PASS | PASS |
| Set 26 | 6 | PASS | PASS | PASS | PASS |
| Set 27 | 5.8 | PASS | PASS | PASS | PASS |
| Set 28 | 5.7 | PASS | PASS | PASS | PASS |
| Set 29 | 5.8 | PASS | PASS | PASS | PASS |
| Set 30 | 5.9 | PASS | PASS | PASS | PASS |

TABLE 1B

| | | Designated Power (W): | | Designated Power (W): | |
|---|---|---|---|---|---|
| | | 1.02459 | | 2.008197 | |
| | | CV (V) | CC (A) | CV (V) | CC (A) |
| | R (Ω) | 2.5 | 0.409836 | 3.5 | 0.57377 |
| Set 1 | 6.1 | PASS | PASS | PASS | PASS |
| Set 2 | 6.1 | PASS | PASS | PASS | PASS |
| Set 3 | 6 | PASS | PASS | PASS | PASS |
| Set 4 | 6.1 | PASS | PASS | PASS | PASS |
| Set 5 | 6.1 | PASS | PASS | PASS | PASS |
| Set 6 | 6.3 | PASS | PASS | PASS | PASS |
| Set 7 | 6.2 | PASS | PASS | PASS | PASS |
| Set 8 | 6 | PASS | PASS | PASS | PASS |
| Set 9 | 5.9 | PASS | PASS | PASS | PASS |
| Set 10 | 6.1 | PASS | PASS | PASS | PASS |
| Set 11 | 5.4 | PASS | PASS | PASS | PASS |
| Set 12 | 5.4 | PASS | PASS | PASS | PASS |
| Set 13 | 5.4 | PASS | PASS | PASS | PASS |
| Set 14 | 5.4 | PASS | PASS | PASS | PASS |
| Set 15 | 5.5 | PASS | PASS | PASS | PASS |
| Set 16 | 5.9 | PASS | PASS | PASS | PASS |
| Set 17 | 5.9 | PASS | PASS | PASS | PASS |
| Set 18 | 6 | PASS | PASS | PASS | PASS |
| Set 19 | 5.9 | PASS | PASS | PASS | PASS |
| Set 20 | 6 | PASS | PASS | PASS | PASS |
| Set 21 | 6.3 | PASS | PASS | PASS | PASS |
| Set 22 | 6.3 | PASS | PASS | PASS | PASS |
| Set 23 | 6.1 | PASS | PASS | PASS | PASS |
| Set 24 | 6.2 | PASS | PASS | PASS | PASS |
| Set 25 | 6.2 | PASS | PASS | PASS | PASS |
| Set 26 | 6 | PASS | PASS | PASS | PASS |
| Set 27 | 5.8 | PASS | PASS | PASS | PASS |
| Set 28 | 5.7 | PASS | PASS | PASS | PASS |
| Set 29 | 5.8 | PASS | PASS | PASS | PASS |
| Set 30 | 5.9 | PASS | PASS | PASS | PASS |

The following tables 2A and 2B demonstrate test results of 30 resistors of 11Ω resistance.

TABLE 2A

| | | Designated Power (W): | | Designated Power (W): | |
|---|---|---|---|---|---|
| | | 0.49308 | | 0.750893 | |
| | | CV (V) | CC (A) | CV (V) | CC (A) |
| | R (Ω) | 2.35 | 0.202586 | 2.9 | 0.25 |
| Set 1 | 11.6 | PASS | PASS | PASS | PASS |
| Set 2 | 11.6 | PASS | PASS | PASS | PASS |
| Set 3 | 11.3 | PASS | PASS | PASS | PASS |
| Set 4 | 11.5 | PASS | PASS | PASS | PASS |
| Set 5 | 11.3 | PASS | PASS | PASS | PASS |
| Set 6 | 11.7 | PASS | PASS | PASS | PASS |
| Set 7 | 11.6 | PASS | PASS | PASS | PASS |
| Set 8 | 11.6 | PASS | PASS | PASS | PASS |
| Set 9 | 11.5 | PASS | PASS | PASS | PASS |
| Set 10 | 11.6 | PASS | PASS | PASS | PASS |
| Set 11 | 11.2 | PASS | PASS | PASS | PASS |
| Set 12 | 11.2 | PASS | PASS | PASS | PASS |
| Set 13 | 11.2 | PASS | PASS | PASS | PASS |
| Set 14 | 11.3 | PASS | PASS | PASS | PASS |
| Set 15 | 11.2 | PASS | PASS | PASS | PASS |
| Set 16 | 11.2 | PASS | PASS | PASS | PASS |
| Set 17 | 11.2 | PASS | PASS | PASS | PASS |
| Set 18 | 11.4 | PASS | PASS | PASS | PASS |
| Set 19 | 11.3 | PASS | PASS | PASS | PASS |
| Set 20 | 11.2 | PASS | PASS | PASS | PASS |
| Set 21 | 12 | PASS | PASS | PASS | PASS |
| Set 22 | 11.7 | PASS | PASS | PASS | PASS |
| Set 23 | 11.5 | PASS | PASS | PASS | PASS |
| Set 24 | 11.2 | PASS | PASS | PASS | PASS |
| Set 25 | 11.8 | PASS | PASS | PASS | PASS |
| Set 26 | 11.9 | PASS | PASS | PASS | PASS |
| Set 27 | 11.9 | PASS | PASS | PASS | PASS |
| Set 28 | 11.7 | PASS | PASS | PASS | PASS |
| Set 29 | 11.6 | PASS | PASS | PASS | PASS |
| Set 30 | 11.9 | PASS | PASS | PASS | PASS |

TABLE 2B

| | | Designated Power (W): | | Designated Power (W): | |
|---|---|---|---|---|---|
| | | 1.002009 | | 2.014509 | |
| | | CV (V) | CC (A) | C V (V) | CC (A) |
| | R (Ω) | 3.35 | 0.288793 | 4.75 | 0.409483 |
| Set 1 | 11.6 | PASS | PASS | PASS | PASS |
| Set 2 | 11.6 | PASS | PASS | PASS | PASS |
| Set 3 | 11.3 | PASS | PASS | PASS | PASS |
| Set 4 | 11.5 | PASS | PASS | PASS | PASS |
| Set 5 | 11.3 | PASS | PASS | PASS | PASS |
| Set 6 | 11.7 | PASS | PASS | PASS | PASS |
| Set 7 | 11.6 | PASS | PASS | PASS | PASS |
| Set 8 | 11.6 | PASS | PASS | PASS | PASS |
| Set 9 | 11.5 | PASS | PASS | PASS | PASS |
| Set 10 | 11.6 | PASS | PASS | PASS | PASS |
| Set 11 | 11.2 | PASS | PASS | PASS | PASS |
| Set 12 | 11.2 | PASS | PASS | PASS | PASS |
| Set 13 | 11.2 | PASS | PASS | PASS | PASS |
| Set 14 | 11.3 | PASS | PASS | PASS | PASS |
| Set 15 | 11.2 | PASS | PASS | PASS | PASS |
| Set 16 | 11.2 | PASS | PASS | PASS | PASS |
| Set 17 | 11.2 | PASS | PASS | PASS | PASS |
| Set 18 | 11.4 | PASS | PASS | PASS | PASS |
| Set 19 | 11.3 | PASS | PASS | PASS | PASS |
| Set 20 | 11.2 | PASS | PASS | PASS | PASS |
| Set 21 | 12 | PASS | PASS | PASS | PASS |
| Set 22 | 11.7 | PASS | PASS | PASS | PASS |
| Set 23 | 11.5 | PASS | PASS | PASS | PASS |
| Set 24 | 11.2 | PASS | PASS | PASS | PASS |
| Set 25 | 11.8 | PASS | PASS | PASS | PASS |
| Set 26 | 11.9 | PASS | PASS | PASS | PASS |
| Set 27 | 11.9 | PASS | PASS | PASS | PASS |
| Set 28 | 11.7 | PASS | PASS | PASS | PASS |
| Set 29 | 11.6 | PASS | PASS | PASS | PASS |
| Set 30 | 11.9 | PASS | PASS | PASS | PASS |

The following tables 3A and 3B demonstrate test results of 30 resistors of 110Ω resistance.

TABLE 3A

| | | Designated Power (W): | | Designated Power (W): | |
|---|---|---|---|---|---|
| | | 0.253897 | | 0.513696 | |
| | | CV (V) | CC (A) | CV (V) | CC (A) |
| | R (Ω) | 5.2 | 0.048826 | 7.4 | 0.069484 |
| Set 1 | 111.1 | PASS | PASS | PASS | PASS |
| Set 2 | 112.9 | PASS | PASS | PASS | PASS |
| Set 3 | 111.2 | PASS | PASS | PASS | PASS |
| Set 4 | 109.8 | PASS | PASS | PASS | PASS |
| Set 5 | 107.3 | PASS | PASS | PASS | PASS |
| Set 6 | 118.4 | PASS | PASS | PASS | PASS |
| Set 7 | 117.9 | PASS | PASS | PASS | PASS |
| Set 8 | 108.4 | PASS | PASS | PASS | PASS |
| Set 9 | 118.8 | PASS | PASS | PASS | PASS |
| Set 10 | 119 | PASS | PASS | PASS | PASS |
| Set 11 | 100.6 | PASS | PASS | PASS | PASS |
| Set 12 | 99.4 | PASS | PASS | PASS | PASS |
| Set 13 | 100.7 | PASS | PASS | PASS | PASS |
| Set 14 | 96.1 | PASS | PASS | PASS | PASS |
| Set 15 | 94.4 | PASS | PASS | PASS | PASS |
| Set 16 | 107.5 | PASS | PASS | PASS | PASS |
| Set 17 | 108.4 | PASS | PASS | PASS | PASS |
| Set 18 | 107.1 | PASS | PASS | PASS | PASS |
| Set 19 | 106 | PASS | PASS | PASS | PASS |
| Set 20 | 102.6 | PASS | PASS | PASS | PASS |
| Set 21 | 112.7 | PASS | PASS | PASS | PASS |
| Set 22 | 108.6 | PASS | PASS | PASS | PASS |
| Set 23 | 108.7 | PASS | PASS | PASS | PASS |
| Set 24 | 105.5 | PASS | PASS | PASS | PASS |
| Set 25 | 109.9 | PASS | PASS | PASS | PASS |
| Set 26 | 97.2 | PASS | PASS | PASS | PASS |
| Set 27 | 94.4 | PASS | PASS | PASS | PASS |
| Set 28 | 98.5 | PASS | PASS | PASS | PASS |
| Set 29 | 98.1 | PASS | PASS | PASS | PASS |
| Set 30 | 96.6 | PASS | PASS | PASS | PASS |

TABLE 3B

| | | Designated Power (W): | | Designated Power (W): | |
|---|---|---|---|---|---|
| | | 1.015587 | | 2.001502 | |
| | | CV (V) | CC (A) | CV (V) | CC (A) |
| | R (Ω) | 10.4 | 0.097653 | 14.6 | 0.137089 |
| Set 1 | 111.1 | PASS | PASS | PASS | PASS |
| Set 2 | 112.9 | PASS | PASS | PASS | PASS |
| Set 3 | 111.2 | PASS | PASS | PASS | PASS |
| Set 4 | 109.8 | PASS | PASS | PASS | PASS |
| Set 5 | 107.3 | PASS | PASS | PASS | PASS |
| Set 6 | 118.4 | PASS | PASS | PASS | PASS |
| Set 7 | 117.9 | PASS | PASS | PASS | PASS |
| Set 8 | 108.4 | PASS | PASS | PASS | PASS |
| Set 9 | 118.8 | PASS | PASS | PASS | PASS |
| Set 10 | 119 | PASS | PASS | PASS | PASS |
| Set 11 | 100.6 | PASS | PASS | PASS | N/A |
| Set 12 | 99.4 | PASS | PASS | PASS | N/A |
| Set 13 | 100.7 | PASS | PASS | PASS | N/A |
| Set 14 | 96.1 | PASS | PASS | PASS | N/A |
| Set 15 | 94.4 | PASS | PASS | PASS | N/A |
| Set 16 | 107.5 | PASS | PASS | PASS | PASS |
| Set 17 | 108.4 | PASS | PASS | PASS | PASS |
| Set 18 | 107.1 | PASS | PASS | PASS | PASS |
| Set 19 | 106 | PASS | PASS | PASS | PASS |
| Set 20 | 102.6 | PASS | PASS | PASS | PASS |
| Set 21 | 112.7 | PASS | PASS | PASS | PASS |
| Set 22 | 108.6 | PASS | PASS | PASS | PASS |
| Set 23 | 108.7 | PASS | PASS | PASS | PASS |
| Set 24 | 105.5 | PASS | PASS | PASS | PASS |
| Set 25 | 109.9 | PASS | PASS | PASS | PASS |
| Set 26 | 97.2 | PASS | PASS | PASS | N/A |
| Set 27 | 94.4 | PASS | PASS | PASS | N/A |
| Set 28 | 98.5 | PASS | PASS | PASS | N/A |
| Set 29 | 98.1 | PASS | PASS | PASS | N/A |
| Set 30 | 96.6 | PASS | PASS | PASS | N/A |

The following tables 4 demonstrate test results of 30 resistors of 280Ω resistance.

TABLE 4

| | | Designated Power (W): | | Designated Power (W): | | Designated Power (W): | |
|---|---|---|---|---|---|---|---|
| | | 0.50087 | | 0.751617 | | 1.005217 | |
| | | CV (V) | CC (A) | CV (V) | CC (A) | CV (V) | CC (A) |
| | R (Ω) | 12 | 0.041451 | 14.7 | 0.050777 | 17 | 0.058722 |
| Set 1 | 289.5 | PASS | PASS | PASS | PASS | PASS | N/A |
| Set 2 | 291.3 | PASS | PASS | PASS | PASS | PASS | N/A |
| Set 3 | 289.4 | PASS | PASS | PASS | PASS | PASS | N/A |
| Set 4 | 288.2 | PASS | PASS | PASS | PASS | PASS | N/A |
| Set 5 | 285.6 | PASS | PASS | PASS | PASS | PASS | N/A |
| Set 6 | 296.8 | PASS | PASS | PASS | PASS | PASS | N/A |
| Set 7 | 296.3 | PASS | PASS | PASS | PASS | PASS | N/A |
| Set 8 | 286.8 | PASS | PASS | PASS | PASS | PASS | N/A |
| Set 9 | 297.2 | PASS | PASS | PASS | PASS | PASS | N/A |
| Set 10 | 297.4 | PASS | PASS | PASS | PASS | PASS | N/A |
| Set 11 | 279 | PASS | PASS | PASS | PASS | PASS | N/A |
| Set 12 | 281 | PASS | PASS | PASS | PASS | PASS | N/A |
| Set 13 | 282 | PASS | PASS | PASS | PASS | PASS | N/A |
| Set 14 | 278 | PASS | PASS | PASS | PASS | N/A | |
| Set 15 | 276 | PASS | PASS | PASS | PASS | N/A | |
| Set 16 | 289.1 | PASS | PASS | PASS | PASS | PASS | N/A |
| Set 17 | 290 | PASS | PASS | PASS | PASS | PASS | N/A |
| Set 18 | 288.7 | PASS | PASS | PASS | PASS | PASS | N/A |
| Set 19 | 287.6 | PASS | PASS | PASS | PASS | PASS | N/A |
| Set 20 | 284.2 | PASS | PASS | PASS | PASS | PASS | N/A |
| Set 21 | 294.9 | PASS | PASS | PASS | PASS | PASS | N/A |
| Set 22 | 290.8 | PASS | PASS | PASS | PASS | PASS | N/A |
| Set 23 | 295.9 | PASS | PASS | PASS | PASS | PASS | N/A |
| Set 24 | 292.7 | PASS | PASS | PASS | PASS | PASS | N/A |
| Set 25 | 297.1 | PASS | PASS | PASS | PASS | PASS | N/A |
| Set 26 | 280 | PASS | PASS | PASS | PASS | PASS | N/A |
| Set 27 | 277 | PASS | PASS | PASS | PASS | N/A | |
| Set 28 | 281 | PASS | PASS | PASS | PASS | PASS | N/A |
| Set 29 | 281 | PASS | PASS | PASS | PASS | PASS | N/A |
| Set 30 | 280 | PASS | PASS | PASS | PASS | PASS | N/A |

From the results of 6Ω resistors detailed in tables 1A and 1B, all 30 sets of 6Ω resistors passed the reliability tests of 0.5 W, 0.75 W, 1 W, and 2 W designated power and of constant voltage and constant current. From the results of 11Ω resistors detailed in tables 2A and 2B, all 30 sets of 11Ω resistors passed the reliability tests of 0.5 W, 0.75 W, 1 W, and 2 W designated power and of constant voltage and constant current. From the results of 110Ω resistors detailed in tables 3A and 3B, all 30 sets of 110Ω resistors passed the reliability tests of 0.5 W, 0.75 W, and 1 W designated power and of constant voltage and constant current. For 2 W designated power, all 30 sets of 110Ω resistors passed the reliability tests of constant voltage. However 10 sets of 110Ω resistors broke during the test of 2 W designated power and of constant current (designating as N/A in the corresponding tables). From the results of 280Ω resistors detailed in tables 4, all 30 sets of 280Ω resistors passed the reliability tests of 0.5 W and 0.75 W designated power and of constant voltage and constant current. However 3 sets of 280Ω resistors broke during the test of 1 W designated power and of constant voltage, and 17 sets of 280Ω resistors broke during the test of 1 W designated power and of constant current. Since some of the 30 sets of 280Ω resistors failed the reliability test at 1 W designated power, the reliability test at 2 W designated power is canceled.

In conclusion, all sets of 6Ω and 11Ω resistors can stably perform under power up to 2 W. All sets of 110Ω resistors can stably perform under power up to 1 W, and at 2 W power with constant current, parts of the sets of 110Ω resistors will break. All sets of 280Ω resistors can stably perform under power up to 0.75 W. At 1 W power with constant voltage, parts of the sets of 280Ω resistors will break, and at 1 W power with constant current, all of the sets of 280Ω resistors will break.

In other words, in embodiments with low resistance values (at 6Ω and 11Ω), the high-power resistor of the present invention can stably perform under power 4 times higher than specified. In embodiments with high resistance values (at 110Ω and 280Ω), the high-power resistor can stably perform under power 2 times higher than specified.

Furthermore, the high-power resistor of the present invention forms the seed layer 21 as the intermedia between the resistor layer 20 and the two edge electrodes 31. This causes the two edge electrodes 31 to tightly connect the resistor layer 20, the thickness of the two edge electrodes 31 to be more than a conventional thickness of a printed conduction layer, and the electrical conductivity to be very good between the resistor layer 20 and the two edge electrodes 31. Therefore, the high-power resistor of the present invention demonstrates practical improvements to prior arts.

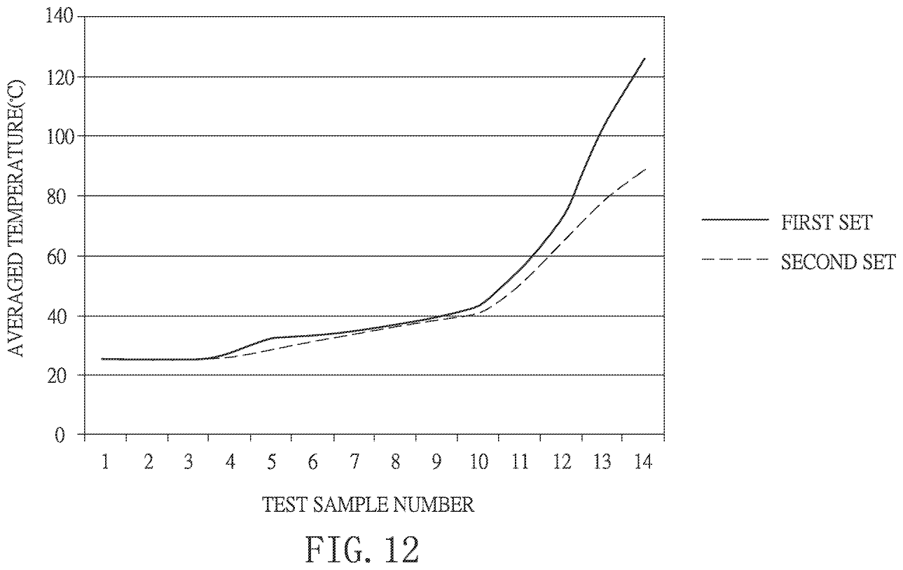

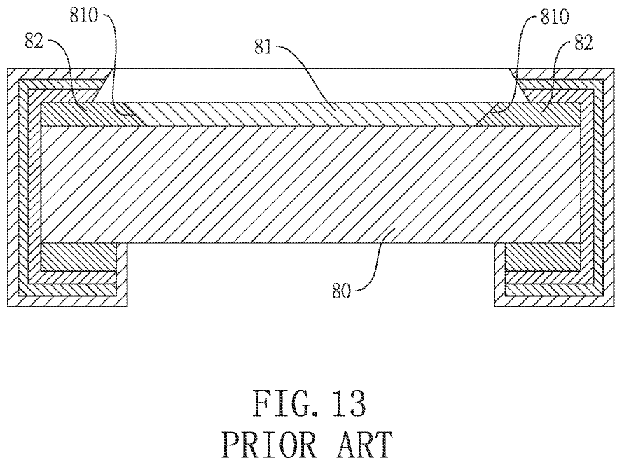

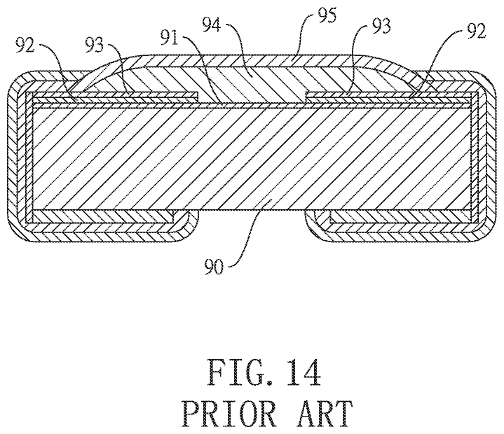

To better demonstrate how the high-power resistor of the present invention is able to dissipate heat and avoid damages caused by excessive high temperatures when conducting high power, the following table 5 and FIG. 12 are shown. Table 5 details test data of how averaged temperature changes for the high-power resistor samples when conducting different powers. The high-power resistor samples detailed here are of surface mount device (SMD) resistor code 1206. In other words, the high-power resistor samples detailed here have dimensions of length about 0.12 inches, width about 0.06 inches, height about 0.022 inches, and standard power about 0.25 Watt.

The high-power resistor samples are divided into a first set and a second set. Though the first set and the second set of the high-power resistor samples differ in thickness of the two edge electrodes 31, the first set and the second set have the same contact areas between two edge electrodes 31 and the resistor layer 20. The thickness of the two edge electrodes 31 is 20 μm for the first set, and the thickness of the two edge electrodes 31 is 35 μm for the second set. Margins of error for the thickness of the two edge electrodes 31 is less than 5.25%, and margins of error of precisions between the first set and the second set is less than 0.1%.

By varying the conducting powers (W) supplied to the first set and the second set, each of the high-power resistor samples has averaged temperature measured and recorded in Table 5 for comparisons. As the conducting powers increase, averaged temperatures of the high-power resistor samples also increase. However, when the conducting powers exceeds 0.25 W, the high-power resistor samples with thicker thickness of the two edge electrodes 31 tend to have more controlled temperature rises. In other words, when the conducting powers exceeds 0.25 W, the second set of the high-power resistor samples evidently has less averaged temperature than the first set.

With reference to FIG. 12, when the conducting powers are below 0.25 W, curves for the first set and the second set tend to overlap. In this situation, the second set of the high-power resistor samples, despite having thicker thickness of the two edge electrodes 31, has limited temperature controls. However, when the conducting powers exceeds 0.25 W, the curve for the second set gradually has lesser slope than the curve for the first set. This evident demonstrates that by having thicker thickness of the two edge electrodes 31, and logically as well as by having the contact areas wider between two edge electrodes 31 and the resistor layer 20, the present invention is able to avoid damages caused by excessive high temperatures through a more controlled rise of the averaged temperature. According to the aforementioned testing data, factors such as thickness of the two edge electrodes 31 of the present invention and the amount of current conducted by the present invention matter most in controlling temperature rises when conducting high power electricity. Therefore, high-power electronics such as machine tools, industrial boilers, network servers, electric vehicles, motors, inverters, transformers, power modules, or any high voltage electronics would have great demand for the high-power resistor of the present invention.

TABLE 5

| | | Averaged | Averaged |
|---|---|---|---|
| Test Sample | Power | Temperature of the | Temperature of the |
| Number | (W) | first set (° C.) | second set (° C.) |
| 1 | 0.005 | 25.4 | 25.4 |
| 2 | 0.01 | 25.4 | 25.4 |
| 3 | 0.02 | 25.4 | 25.4 |
| 4 | 0.075 | 27.2 | 26.4 |
| 5 | 0.1 | 32.4 | 28.7 |
| 6 | 0.125 | 33.2 | 31.3 |
| 7 | 0.15 | 34.5 | 33.5 |
| 8 | 0.175 | 36.3 | 36.7 |
| 9 | 0.2 | 39.5 | 38.6 |
| 10 | 0.25 | 42.8 | 40.8 |
| 11 | 0.35 | 54.5 | 50.1 |
| 12 | 0.42 | 71.1 | 63.7 |
| 13 | 0.53 | 102.2 | 78.6 |
| 14 | 0.75 | 125 | 88 |

The above only describes the various embodiments of the present invention, rather than limitations to the present invention. Although the embodiments of the present invention are revealed, any technical personnel in related fields are free to utilize the revealed technical detail stated above and make slight equivalent changes as different embodiments of the present invention within the boundary of what is claimed for the present invention. All equivalent changes made in relation to what is claimed for the present invention are all encompassed by what is claimed for the present invention.

What is claimed is:

1. A high-power resistor, comprising:
a substrate, having a first surface;
a resistor layer, mounted on the first surface of the substrate;
two edge electrodes, mounted on the resistor layer; and
a seed layer, mounted between the resistor layer and the two edge electrodes, and being conductive.

2. The high-power resistor as claimed in claim 1, further comprising:
a first protective layer, covering the resistor layer between the two edge electrodes, wherein the a height of an edge of the first protective layer contacting the two edge electrodes is lower than a height of a top surface of the two edge electrodes; and
a second protective layer, mounted on the first protective layer, and covering the first protective layer.

3. The high-power resistor as claimed in claim 1, wherein:
the substrate further comprises two side surfaces, the first surface, and a second surface facing opposite direction to the first surface;
the high-power resistor further comprises:
two bottom electrodes, mounted on the second surface;
two side surface seed layers, being conductive, and mounted on the two side surfaces of the substrate, wherein the two side surface seed layers stretch from the first surface to the second surface, and wherein the two side surface seed layers electrically connect the two edge electrodes and the two bottom electrodes;
two first conducting layers, mounted on the two side surface seed layers; and
two second conducting layers, mounted on the two first conducting layers.

4. The high-power resistor as claimed in claim 3, further comprising:
two intermedia layers, mounted between the two side surface seed layers and the two side surfaces of the substrate, wherein the two intermedia layers are made of materials such as titanium or copper.

5. The high-power resistor as claimed in claim 1, wherein an equivalent resistance of the high-power resistor is an equivalent resistance of the resistor layer and an equivalent resistance of the two edge electrodes connected in parallel summed in series.

6. The high-power resistor as claimed in claim 1, wherein the equivalent resistance of the high-power resistor can be written as:
R3=(R1′*R2)/(R1′+R2)+R1″+(R1′*R2)/(R1′+R2); wherein:
R3 represents the equivalent resistance of the high-power resistor, R1′ represents an equivalent resistance of an overlapping part of the resistor layer with the two edge electrodes, R1″ represents an equivalent resistance of an exposed part of the resistor layer with the two edge electrodes, and R2 represents an equivalent resistance of the two edge electrodes.

7. The high-power resistor as claimed in claim 1, wherein a material resistance of the resistor layer is greater than a material resistance of the seed layer or a material resistance of the two edge electrodes.

8. The high-power resistor as claimed in claim 1, wherein the two edge electrodes and the seed layer are made of same metallic materials.

9. The high-power resistor as claimed in claim 1, wherein the two edge electrodes and the seed layer are made of different metallic materials.

10. The high-power resistor as claimed in claim 1, wherein the resistor layer is made of titanium alloy, copper-silver alloy, manganese-copper alloy, nickel-copper alloy, titanium nitride, or tantalum-aluminium-nitride.

11. The high-power resistor as claimed in claim 1, wherein the resistor layer is made of nickel-chromium alloy.

12. The high-power resistor as claimed in claim 11, wherein the resistor layer is made of nickel-chromium-copper alloy or nickel-chromium-silicon alloy.
